(19) United States
(12) Patent Application Publication
(10) Pub. No.: US 2007/0288519 A1
(43) Pub. Date: Dec. 13, 2007

(54) Diagnosis, complaint or symptom-driven electronic medical record information query

(76) Inventor: James S. Ford, Kailua, HI (US)

Correspondence Address: JAMES FORD, 1379 AUWAIKU ST., KAILUA, HI, 96734, US

(21) Appl. No.: 11/759,245

(22) Filed: Jun. 7, 2007

Related U.S. Application Data
(60) Provisional application No. 60/804,097, filed on Jun. 7, 2006.

(51) Int. Cl. G06F 7/00

(52) U.S. Cl. 707/104.1

(57) ABSTRACT

A query protocol that retrieves all pertinent information from the electronic medical record based on the patient's current diagnosis, complaint or symptom. The query of the electronic medical record will include but not be limited to all relevant prior visits/hospitalizations (including all information contained therein ie. vital signs, review of systems, physical exam findings) surgeries, procedures, radiology studies, laboratory tests, medications and allergies. The relevant information will be organized so that it is easily interpreted for viewing or printing. A list of medical abbreviations was also developed, which may be used in conjunction with the query protocol, so as to minimize storage space needed in the organization of the data.

### CROSS-REFERENCE TO RELATED APPLICATIONS

Provisional patent application filed Jun. 7, 2006 entitled “Diagnosis, complaint or symptom-driven electronic medical record information query” EFS ID#1069675 Application #60804097 Confirnation#4477

### DESCRIPTION

1. Field of the Invention

This related to the method of searching electronic medical records.

2. Background of the Invention

In part, the advent of the electronic medical record (EMR) was driven by the need to organize and gain easy access an ever-growing database of patient information. While the EMR made information easier to find, the vast amount of information available makes it increasingly difficult to find information relevant to a patient's active problem. This difficulty in obtaining pertinent information, coupled with constantly increasing demands on physician time, make performing a thorough and accurate search of patient information challenging.

The nature of medicine is also such that it is more and more common that a covering physician who is naïve a patient's relevant history will be the treating physician as opposed to the designated primary care physician. The result is physicians are often treating without a complete picture of the patient's relevant history. This raises the potential for harm to come to the patient due to inadequate information.

The time taken to review the EMR is time taken away from the active care of the patient. Applying the concept of a complaint or diagnosis-based query or search to provide more thorough and relevant searches of the EMR will improve patient care, increase physician efficiency and reduce errors based on lack of information.

While the aforementioned description addresses how the diagnosis, complaint, or symptom-based query will benefit the physician's ability to practice medicine, this system need not be limited to the use of physicians. As patients become more medicine and computer savvy, they are increasingly involved in decisions regarding their own care. In response to this, many EMRs now have dedicated areas the patient can access. Should the health care provider feel it is appropriate for the patient to have access to their records, this system could serve as a way for patients to be better informed about their own health conditions. Providing a concise summary of the patient's active medical problem can assist in making intelligent, informed decisions.

The concept represents a departure from what is currently possible in the realm of electronic medical records in that it allows the user to perform searches with a precision and speed not available from past systems. Furthermore if the software is programmed to tag individual elements from within a specific medical encounter, surgical procedure or hospital admission, then the end user will be able to perform even more refined searches.

The development of standardized nomenclature for this query system was necessary to ensure cross-system compatibility. The nature of a medical record system as a whole is that it is ever-expanding. The naming system was developed using the least number of characters per name possible so as to minimize storage spaced needed in a database.

By allowing a combination of abbreviations from the list, a nearly infinite combination of laboratory tests, body parts, medical complaints, diagnoses, diseases, radiologic imaging, procedures and surgeries can be used to tag the data for later retrieval. It includes a complete yet not exhaustive list of terms that can be modified or expanded based on an individual user's needs.

### SUMMARY OF THE INVENTION

The present invention describes a complaint or diagnosis-related query of an EMR. A novel system of medical abbreviations was developed for use with the query program.

The individual performing the EMR search chooses from a pre-populated list or enters the diagnosis, complaint or symptom (key word) of interest. The key phrase can be queried alone or in conjunction with a modifier or additional key phrases. The query of the EMR will provide a summary of clinical and laboratory information relevant to the key phrase(s). The information will be organized in an easily viewed fashion from which more detailed reports can be obtained at the discretion of the individual performing the search. By selecting highlighted information, details about the selection could be accessed.

The data will consist of a core set of data that is pertinent to any medical encounter. This core set of data shall include the patient's vital signs, medications, allergies and demographic information. This core data could be expanded to include the patient's past medical history and family history (for example) at the discretion of the end-user. The variable data will consist of a set of data specific to the key phrase selected. The data shall be identified using the standardized nomenclature system (see FIG. 7). By using a standardized set of metadata, it will be much easier to share data across systems.

The concept signifies a significant departure from the current standard of laboriously sifting through the entire EMR in an effort to extract the relevant data. The key phrase-based EMR query will take information normally stored in disparate areas of the EMR and display them in a unified, organized fashion. This saves the individual performing the search the time of having to identify both where to find that information and determine which information is relevant.

There are a number of ways a system could be set up to locate and relate relevant data. Perhaps the most simple would be to use time-stamped metadata to identify the data and then create keyword-specific relationships with the software. One of the issues is the lack of standardized medical abbreviations for naming the data so that there can be cross-system compatibility.

So as to improve cross-platform compatibility, improve information retrieval speed and minimize computer storage space needed, a set of standardized abbreviations was developed. The abbreviations were developed for the vast majority of laboratory tests, body parts, radiological studies, interventions, diagnoses and complaints but is not exhaustive and as such could be modified or augmented. The naming system first lists the name of primary test, body part, intervention or diagnosis followed by any necessary modifiers (such as left, right, total, partial, for example). The least number of characters possible were used in consideration of minimizing computer memory space necessary.

A list of medication and allergy names was intentionally omitted as such a list would be prohibitively large and ever-growing. The abbreviation list was developed to aid in the storage and retrieval of data pertaining to a specific patient encounter. It is assumed that an updated medication and allergy list would always be included with the relevant past medical history, laboratory values, radiologic imaging and surgeries obtained from the data query. Unlike the other components displayed based on the results of the keyword-driven search, the medication and allergy list remains relatively static and would be included in its entirety each time a query is performed. As such, it is not as critical to tag the medications and allergies for data storage and retrieval. The only drug names included are those commonly tested in laboratory testing.

### BRIEF DESCRIPTION OF THE DRAWINGS

FIG. 1 shows a general flow diagram of how the key phrase-related query will be used to facilitate data finding by the user.

FIG. 2 is a table of 6 possible key phrases and correlating relevant information that would be retrieved from the electronic medical record and then displayed for the end-user's viewing. The actual number of diagnoses, complaints and symptoms (key phrases) used in medicine is obviously significantly greater than the 6 listed—this is simply meant as an illustrative example. The key phrases can be added or deleted based on the end-user's needs. Relevant data retrieved based on the key phrase also can be customized based on the end-user's needs.

FIG. 3 is a diagram showing that the key phrase can be chosen by either scrolling through a drop-down list or manually entered.

FIG. 4 demonstrates how a modifying key word(s) can be used to limit the amount of information from the EMR query.

FIG. 5 is a diagram of how multiple key phrases can be combined. FIG. 5a combines the key phrase searches with the word AND, thus only data common to each of the phrase word queries is displayed. FIG. 5b combines the key phrase searches with the word OR, thus all data from each phrase word query is displayed. In each case, overlapping data is only displayed one time.

FIG. 6 is a diagram of a possible example of how the data generated from combining multiple key phrases differs using the combining word AND or OR. In this case, the query from chest pain AND shortness of breath results in only the data common to the two complaints. Combining the searches chest pain or shortness of breath results in all data resulted from each complaint's query.

FIG. 7 is a list of medical abbreviations that can be associated a wide variety of laboratory tests, body parts, complaints and diagnoses, radiologic imaging modalities, surgeries and procedures. The list of abbreviations is shown with upper and lower-case letters but was designed so as to NOT be case sensitive. A list of the abbreviations can be strung together, separated by spaces, to create an extensive list of complaints, diseases, laboratory tests, imaging studies and procedures. Some of such combinations are demonstrated within the list but a myriad of such combinations is possible and as such, most are not explicitly shown. For example, the condition Pain, represented by Pa, could be combined with a wide variety of body parts and used as a keyword. Some examples would be Pa Hd would represent head pain. This could be distinguished from Ache Hd or Lac Hd, which would represent Headache and Head Laceration, respectively. While some of the procedures are broken down in to subspecialty medical and surgical categories for purpose of display, the terms are generalizable to any field.

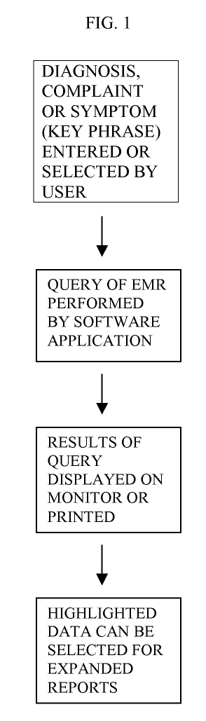

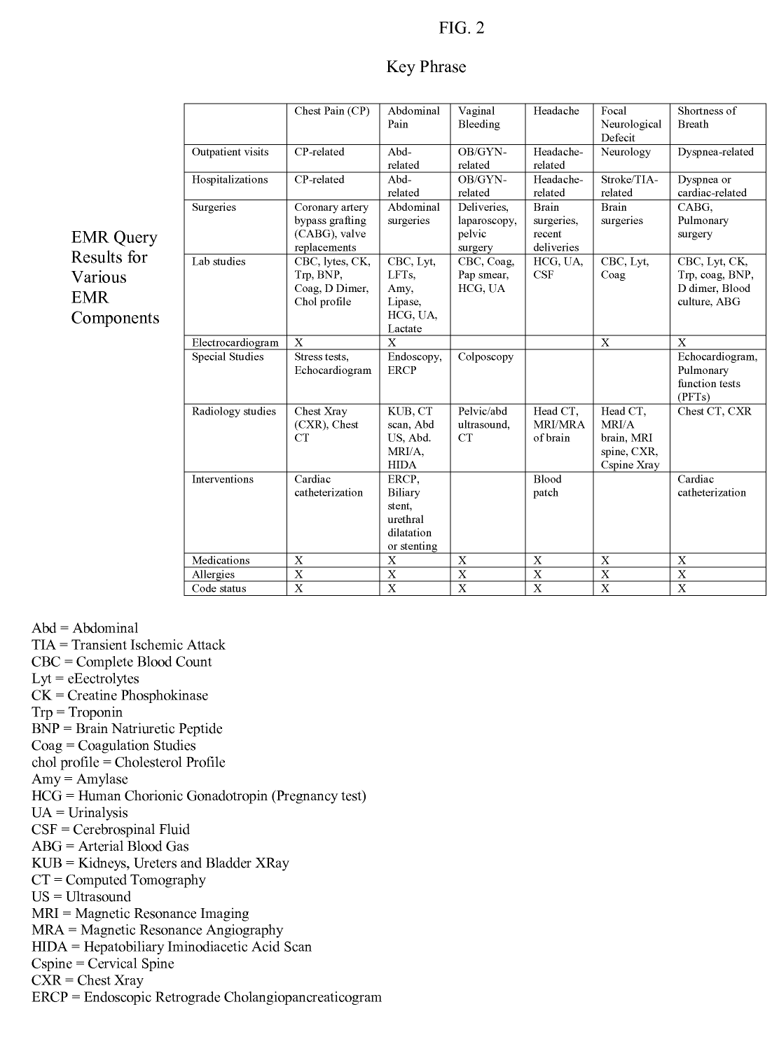

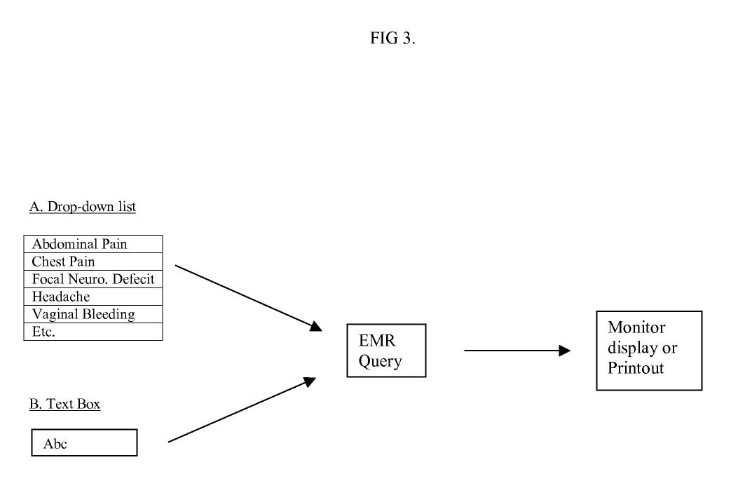

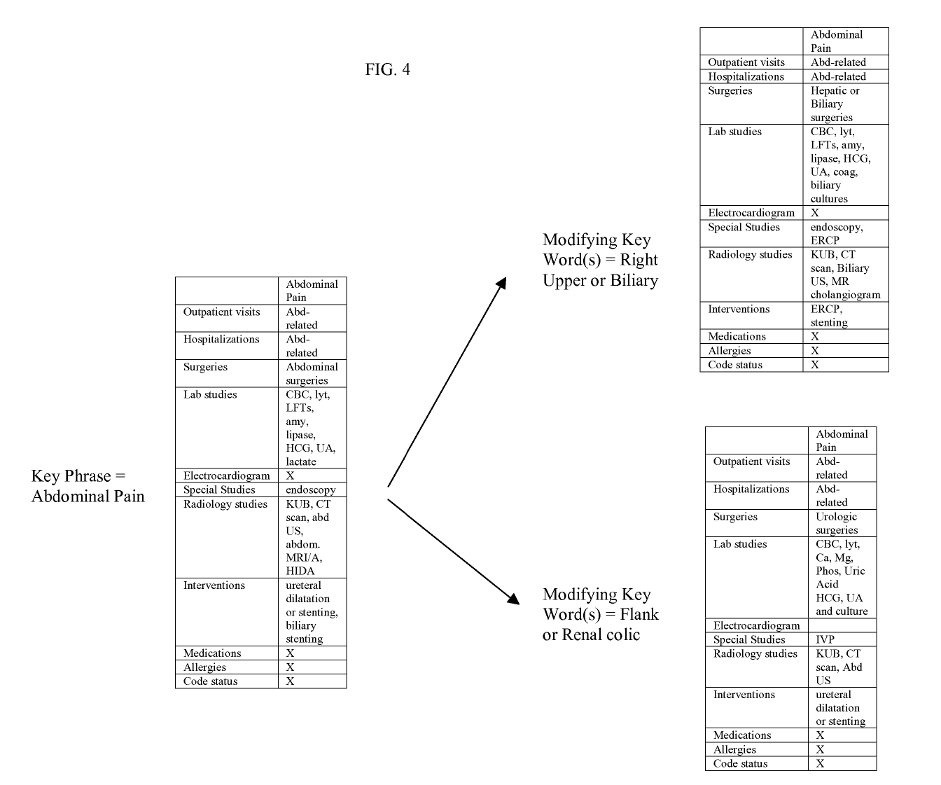

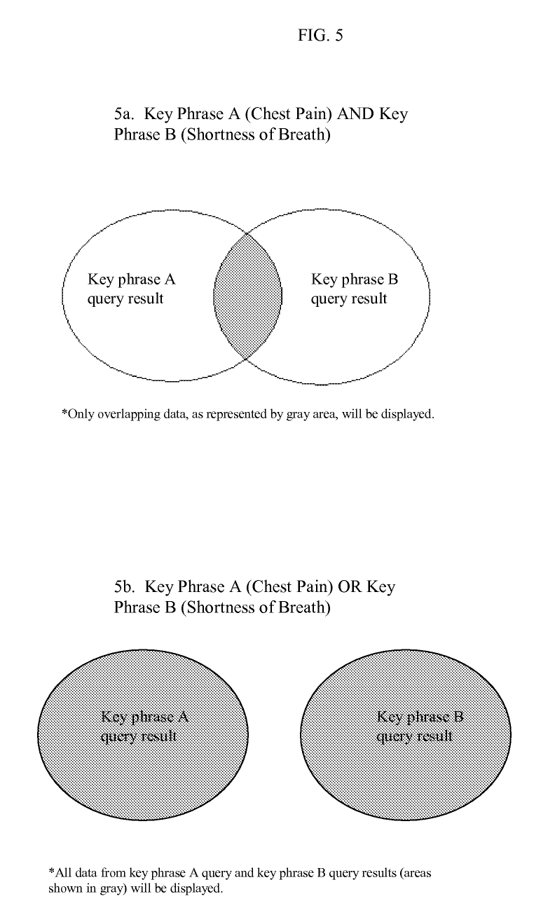

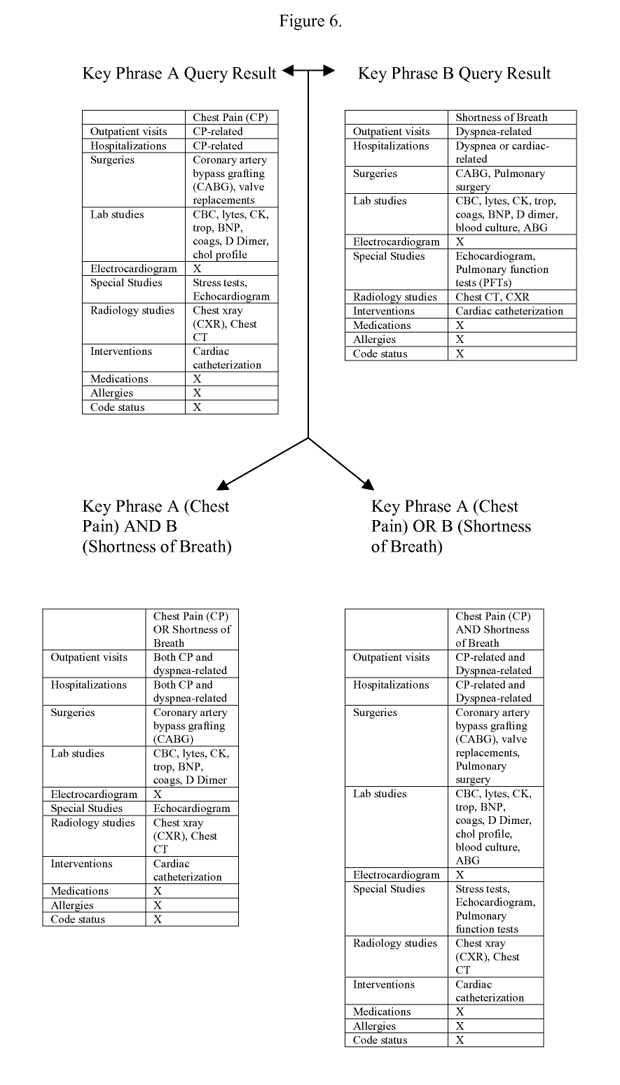

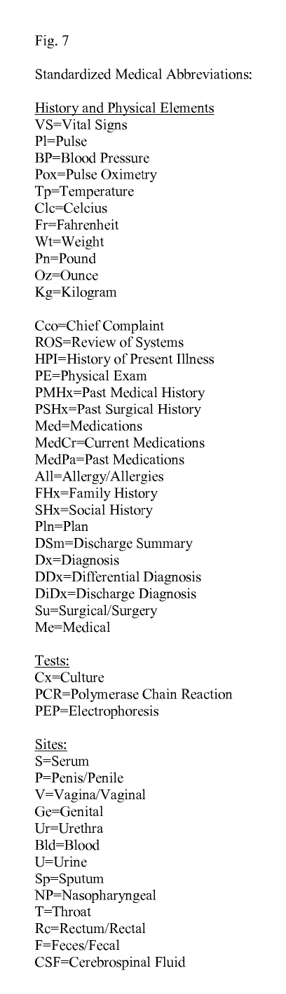

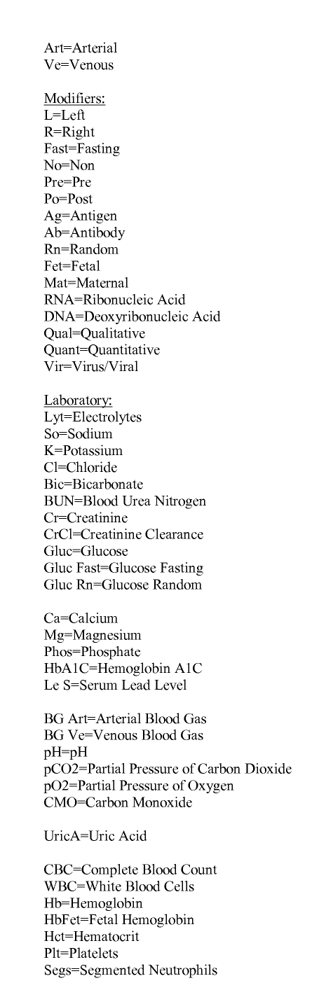

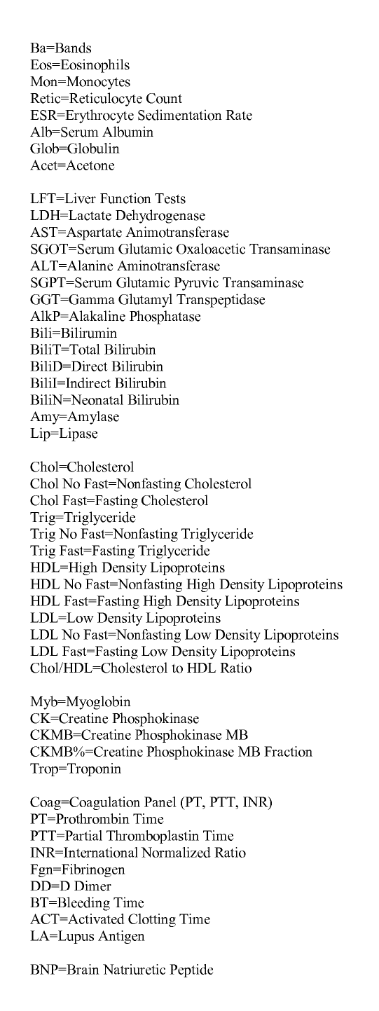

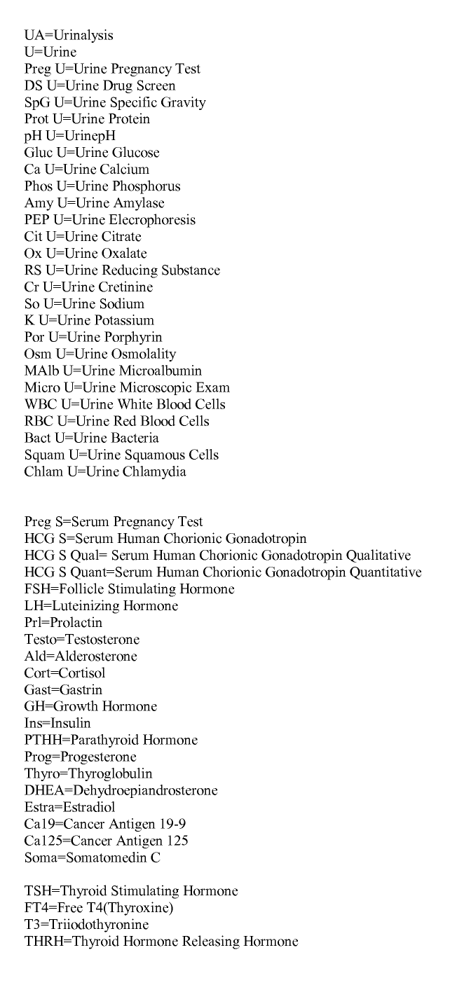

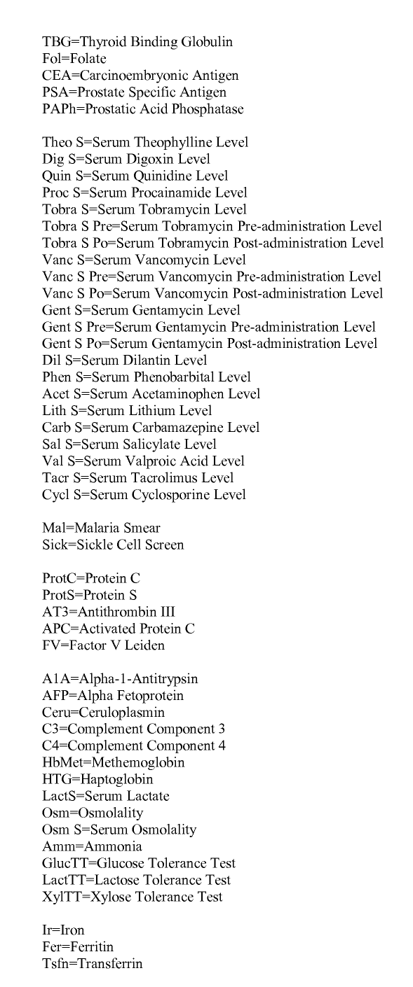

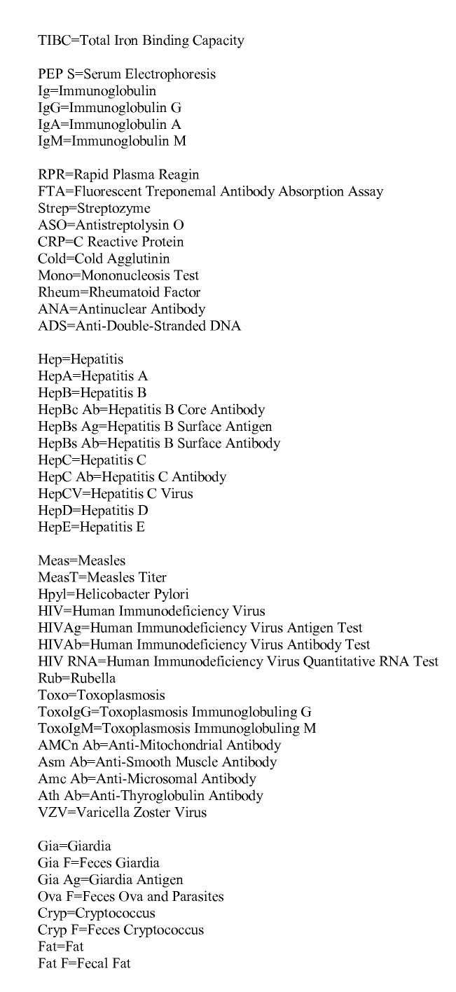

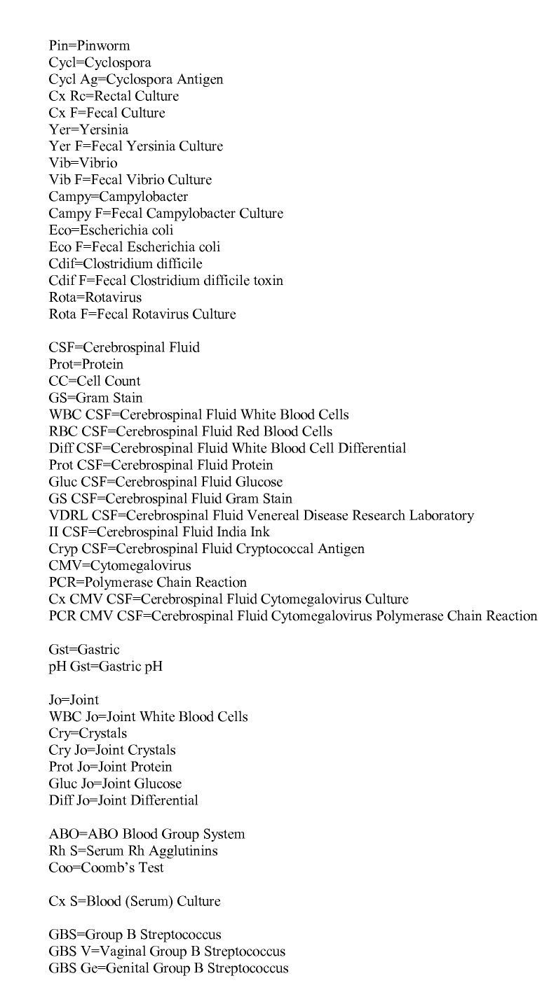

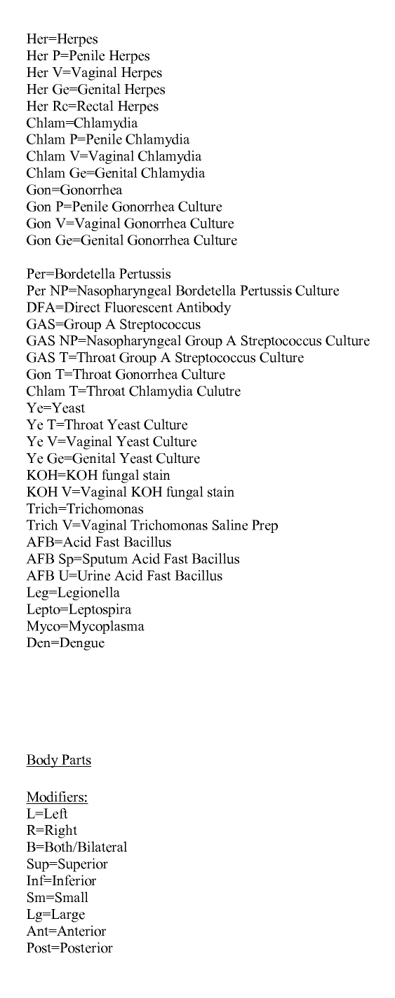

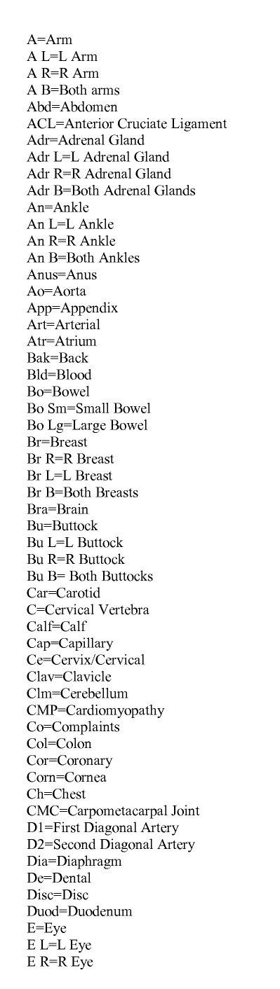

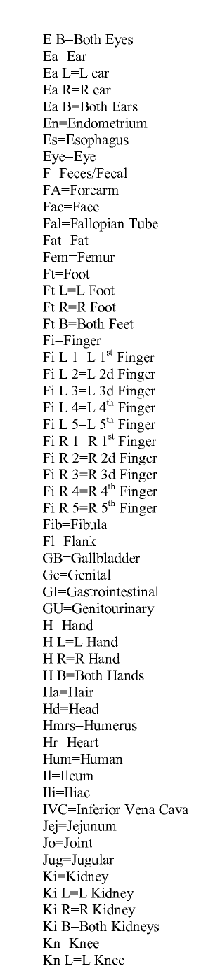

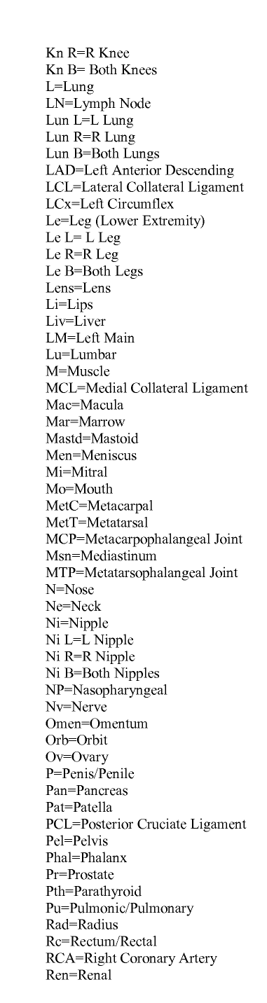

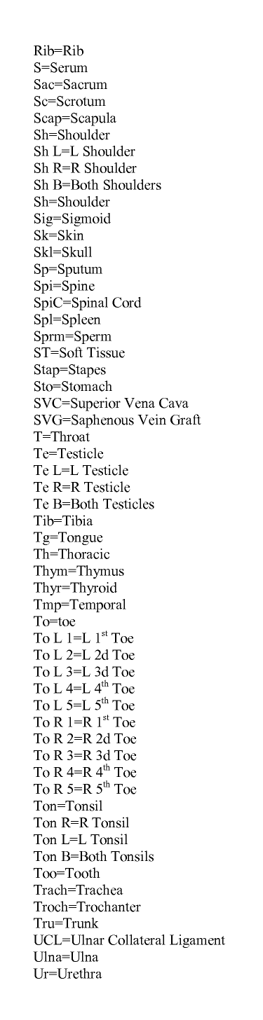

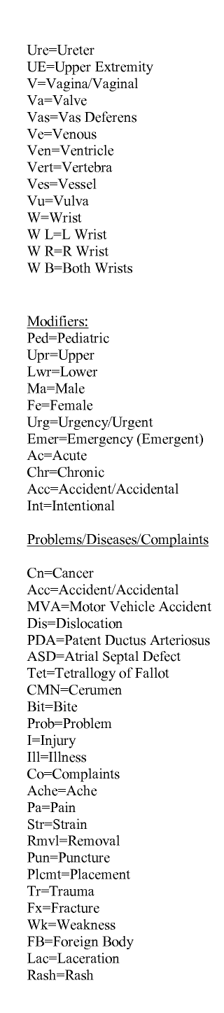

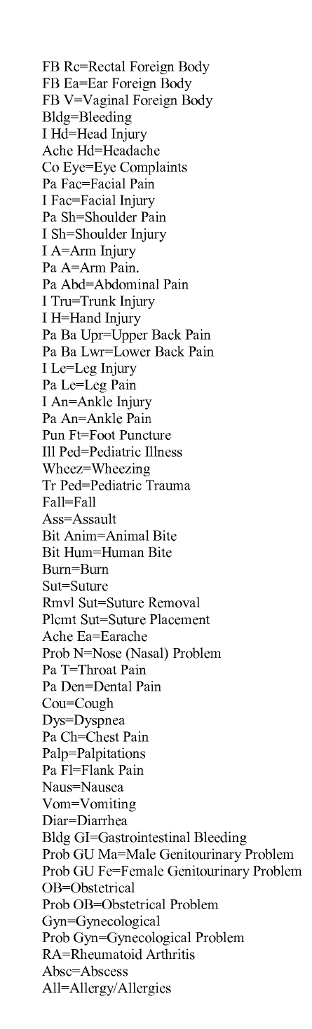

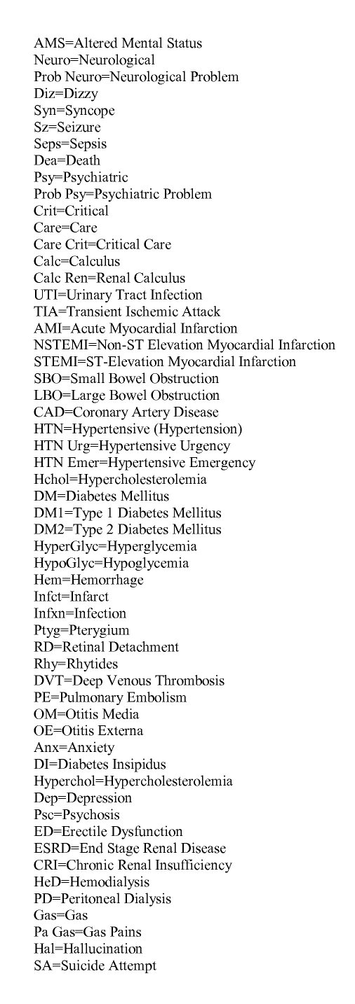

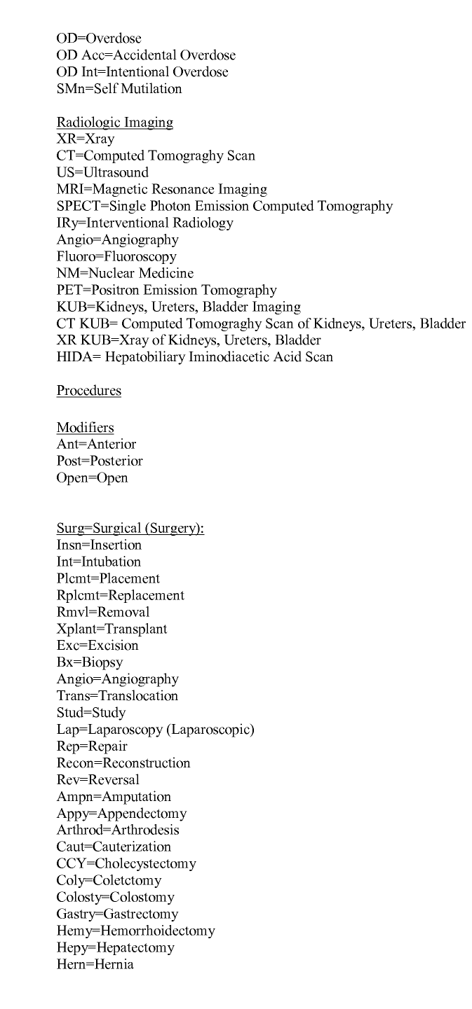

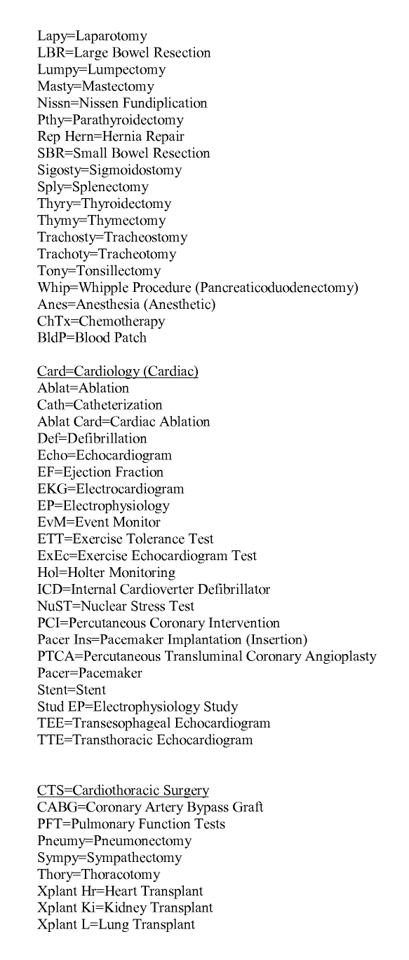

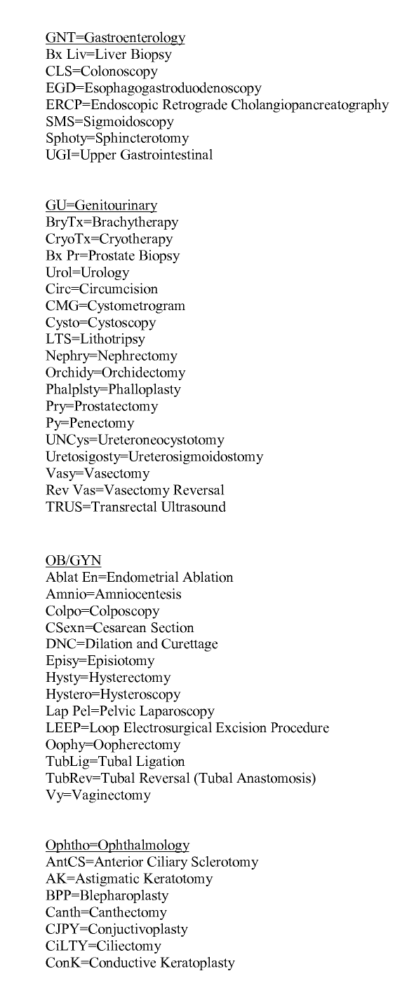

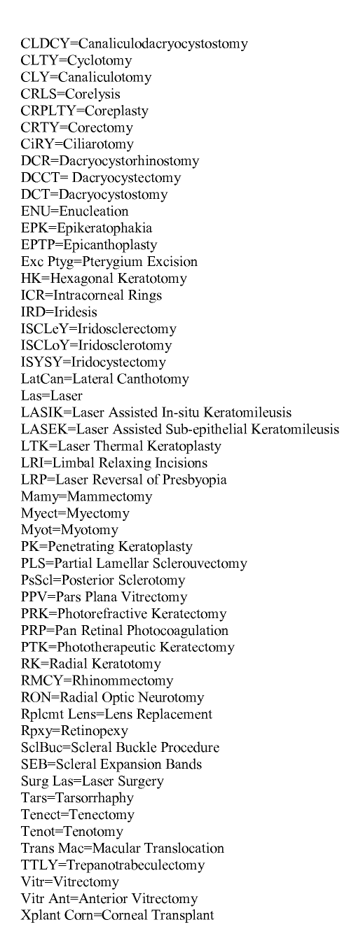

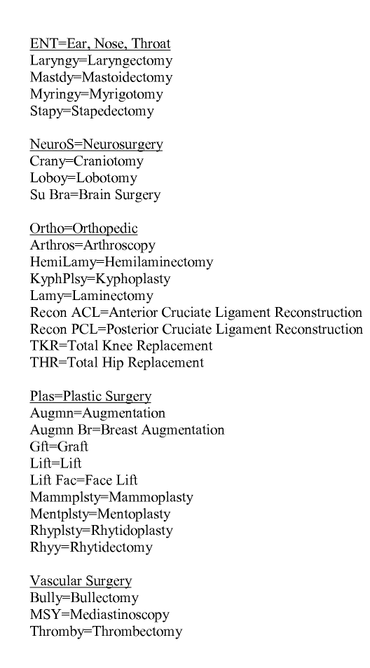

What is claimed is:

1. A method of searching an electronic medical record that compiles a set of information relevant to a specific diagnosis, complaint or symptom (key phrase) comprising:
a means to choose a key phrase from a pre-populated list or manually enter the key phrase which will trigger a query of a patient's electronic medical record (EMR),
a set of data related to said key phrase that will be organized and displayed for easy review,
said data composed of core data elements relevant to all patient encounters (vital signs, medications, allergies, demographics) and variable elements related to the key phrase identified by data tags,
a system for display such that should the result of the query based on said key phrase relate to data not amenable to display on a single page (ie. hospital admissions, office visits, radiology images or reports, laboratory reports, medication frequency/dates ordered and renewed, specific reactions to medications), that data will be highlighted or distinguished;
by selecting the highlighted data, a detailed report will then be accessed.

2. The method of claim 1 by which the specific data accessed and displayed related to a certain key phrase can be derived from a pre-determined set of information associated with the key phrase;
or the query based on the specific key phrase can be customized to best suit the needs of the individual performing the query.

3. The method of claim 1 including a system to create individual user profiles/unique identifiers to store individual preferences of said individual performing the query.

4. The method of claim 1 by which the operator can also create a customized key phrase and query based on that key phrase.

5. The method of claim 1 by which the operator can also customize the key phrase list based on his or her needs.

6. The method of claim 1 wherein to further refine the query generated by the key phrase, one or more modifying key word(s) can be added at the discretion of the operator.
said modifying key word(s) will serve to limit the information displayed to include a subset of the data from the query generated by the primary key phrase.

7. The method of claim 1 by which selection of two or more separate primary key phrases will give the option of expanding the search to include the data from the query generated by each of the primary key phrases;
if the option to query the primary key phrase A OR key phrase B then all data from the query associated with key phrase A and key phrase B will be displayed. In the event there is data that overlaps when key phrase A and key phrase B queries are performed. Overlapping data will only be displayed once;
if the option to query the primary key phrase A AND key phrase B, only data common to each complaint/diagnosis query will be displayed. Overlapping data will only be displayed once.

8. The method of claim 1 that may utilize a naming system to include a proposed standardized nomenclature for laboratory results, radiological tests, interventions, body parts, medical diagnoses and complaints;
said naming system allows for the combining of the various abbreviations so as to create an even more comprehensive and descriptive listing of laboratory tests, body parts, drugs, medical complaints, diagnoses, diseases, radiologic imaging, procedures and surgeries;
said naming system may be combined with a time/date stamp so as to identify individual data elements for retrieval and storage;
said naming system may be used to tag individual elements from a past medical encounter or hospital admission/discharge (such as the vital signs, medications, allergies, physical exam, past medical history, past surgical history and plan) so as to further refine a data search;
said naming system which can be modified by the end user to include abbreviations not included in the original version of said naming system.
